(19) United States
(12) Patent Application Publication
(10) Pub. No.: US 2007/0132748 A1
(43) Pub. Date: Jun. 14, 2007

(54) Screen display with sound lamps

(76) Inventor: Hae-Yong Choi, Seoul-City (KR)

Correspondence Address: BACON & THOMAS, PLLC, 625 SLATERS LANE, FOURTH FLOOR, ALEXANDRIA, VA, 22314, US

(21) Appl. No.: 11/650,493

(22) Filed: Jan. 8, 2007

(30) Foreign Application Priority Data
Sep. 28, 2006 (KR) 10-2006-0094466
Dec. 9, 2005 (KR) 10-2005-0120260
Dec. 20, 2005 (KR) 10-2005-0127502

(51) Int. Cl. G09G 5/00

(52) U.S. Cl. 345/204

(57) ABSTRACT

Disclosed herein is a screen display which enables visual change of light related to sounds to be exhibited along with images on the screen. The screen display comprises a frame surrounding the screen display to couple a plurality of lamps to the screen display, a lamp line constituted by the plurality of lamps within the frame, a sensor, and a signal converter connected to the lamp line. Variation in illumination and colors of the lamps is shown on the screen along with images, so that the images and the visual change of light related to the sounds are shown on a single screen display.

### BACKGROUND OF THE INVENTION

1. Field of the Invention

The present invention relates to a screen display with sound lamps, and, more particularly, to a screen display, which comprises sound lamps capable of being changed in illumination and color thereof on the screen in response to sound signals in cooperation with a signal converter to convert the sound signals to electric signals, enabling visual change of light from the lamps related to sounds to be exhibited along with images on the screen.

2. Description of the Related Art

Recently, large screen displays for video game rooms or song rooms such as Karaoke have been increasingly demanded.

For the song rooms, although an illuminator is provided along with a separate sound system to the display, the illuminator is generally realized by a lamp which is a separate component and has a simple flashing function.

Since such a separate structure of the illuminator is positioned outside the screen display, it does not provide a particular visual effect to a user, in particular, in the case of a screen display on which the words of songs or the contents of video games must be shown.

For the video game rooms, since large screen displays are increasingly demanded for the purpose of imparting actuality and three-dimensional effects to video images, and such actuality and three-dimensional effects of the video images cannot be satisfactorily obtained only through screen effects, there are needs of devices for increasing the actuality of the games.

### SUMMARY OF THE INVENTION

The present invention has been made to solve the above problems, and it is an aspect of the present invention to provide a screen display, which comprises sound lamps integrated therewith to allow illumination thereof to be varied in connection with rhythm and intensity of sounds, and to allow words of songs, video images, and variation of the illumination from the sound lamps to be shown on a screen of the display in such a way that, for application to video game rooms, illumination around the screen display is changed in response to the rhythm and intensity of sounds changed according to the contents of video games, thereby increasing actuality of the video games, and for application to song rooms, illumination around the screen is changed in response to the rhythm of songs, thereby further increasing the amusement of singers.

It is another aspect of the present invention to provide the screen display, which can increase interest for advertising images shown on the screen of the display by attracting customer's eyes by a moving effect of the lamps on the circumference of the screen display when using the screen display of the invention as an advertising display, thereby increasing an image advertising effect.

In accordance with one aspect of the present invention, the above and other objects can be accomplished by the provision of a screen display for image projection, the improvement comprising: a frame surrounding the screen display to couple a plurality of lamps to the screen display; a lamp line constituted by the plurality of lamps within the frame; and a sensor connected to the lamp line, wherein variation of the lamps by operation of the sensor is shown on the screen display along with an image.

### BRIEF DESCRIPTION OF THE DRAWINGS

The foregoing and other objects and features of the present invention will be more clearly understood from the following detailed description taken in conjunction with the accompanying drawings, in which:

FIG. 1 is a perspective view of a screen display according to one embodiment of the present invention;

FIG. 2 is a cross-sectional view of the screen display shown in FIG. 1, in which sound lamps are integrated to the screen display;

FIG. 3 is an explanatory view of the sound lamps of the invention;

FIG. 4 is a view illustrating the overall configuration of the sound lamps of FIG. 3; and

FIG. 5 is an explanatory view of a usage of the screen display of the invention.

### DETAILED DESCRIPTION OF THE PREFERRED EMBODIMENTS

Preferred embodiments of the present invention will be described in detail with reference to the accompanying drawings, through which like components are denoted by the same reference numerals.

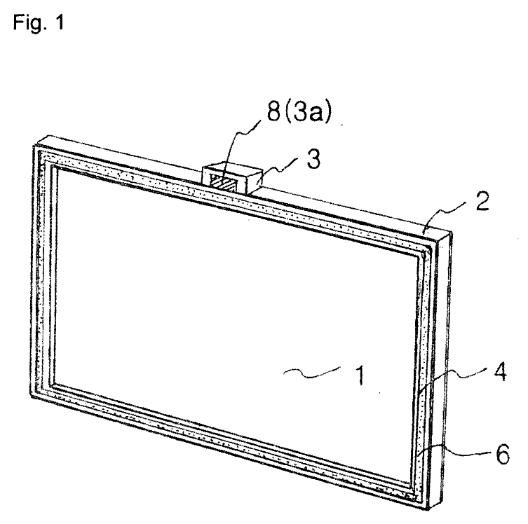

Referring to FIG. 1, the screen display 1 according to the present invention comprises a frame 2 to couple lamps to the screen display 1, the lamps 5 received in the frame 2, and a sensor 8 to operate the lamps 5.

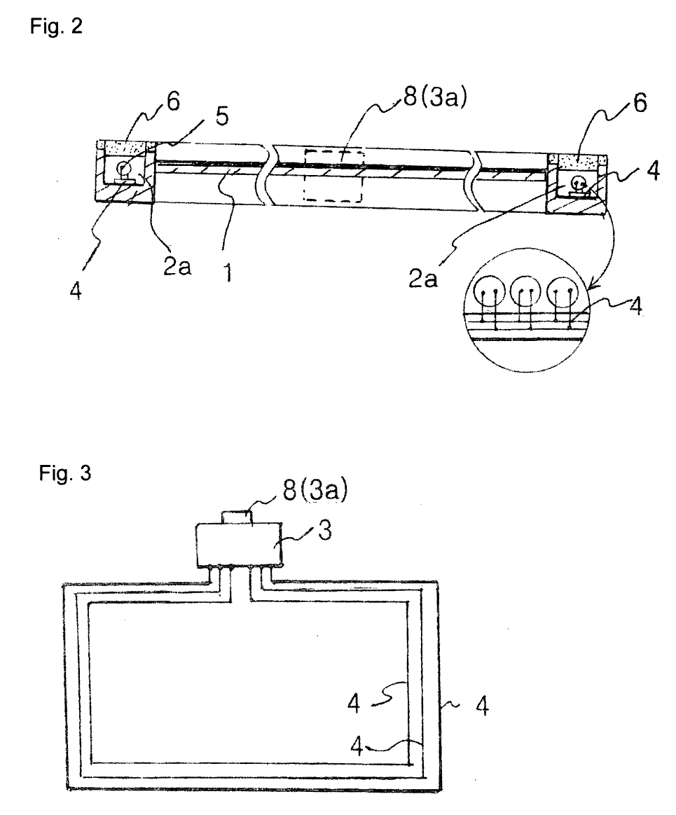

In this embodiment, the screen display comprises a plurality of lamps 5 disposed along a lamp line 4 positioned in a recess line within the frame 2, as shown in FIG. 2, such that the lamps 5 are exposed from or received in the frame 2. The lamps 5 are connected to the sensor 8 or any of converters capable of changing lamp signals, and a signal converter 3 capable of converting sound signals to electric signals.

The screen display 1 may be any one of screen displays such as transmissive screens, reflective screens, high brightness screens, and other screens, such as PDPs and LCDs, which can directly display images thereon.

The signal converter 3 may comprise any one of converters which can detect various sound signals such as music, sound effects, etc., and can convert the detected sound signals into the electric signals to cause illumination of the lamps.

The signal converter 3 may be a sound controller which can activate the lamps 5 according to program.

The lamps 5 may be any of neon lamps, LEDs, LED lines, and other lamps known in the art. Preferably, the lamps 5 are constituted by the neon lamps or the LEDs in terms of durability.

The lamps 5 are configured to change in colors and illumination according to variation of sounds. For example, a lamp for emitting white color is first turned on in response to a strong sound. Then, other lamps for emitting red, green, etc. are sequentially turned on according to the strength of the sound. It should be noted that the invention is not limited to this configuration, and that the lamps may be realized in various configurations. Alternatively, the lamps are constituted such that the illumination of the lamps can also be sequentially changed according to the strength of the sound.

Furthermore, a diffusion plate 6 may be disposed on the frame to cover the lamps 5 to smoothly spread the tone of color emitted from the lamps. For the screen display of video game rooms, the lamp line 4 may be further provided with an illuminator, such as a flash lamp capable of instantly emitting light for strong stimulation or a laser device, of which illumination is changed in response to sound levels.

According to the invention, it is possible to provide various environments according to the contents of games or music by use of the lamps with various memory circuits.

The sensor 8 may be a detection sensor or a sound sensor 3a. Alternatively, the signal converter is configured to directly receive an output signal from a sound amplifier.

One embodiment of the screen display according to the invention will be described in detail with reference to the accompanying drawings.

Referring to FIGS. 1 and 2, the screen display 1 of the embodiment comprises a frame 2 which surrounds the screen display 1 and is formed therein with a lamp line 4 or a lamp installation groove 2a to which multiple lamps 5 are coupled.

Since it is difficult to individually operate the lamps 5, the lamps 5 are connected and operated via a single electric wire, such as the lamp line 4.

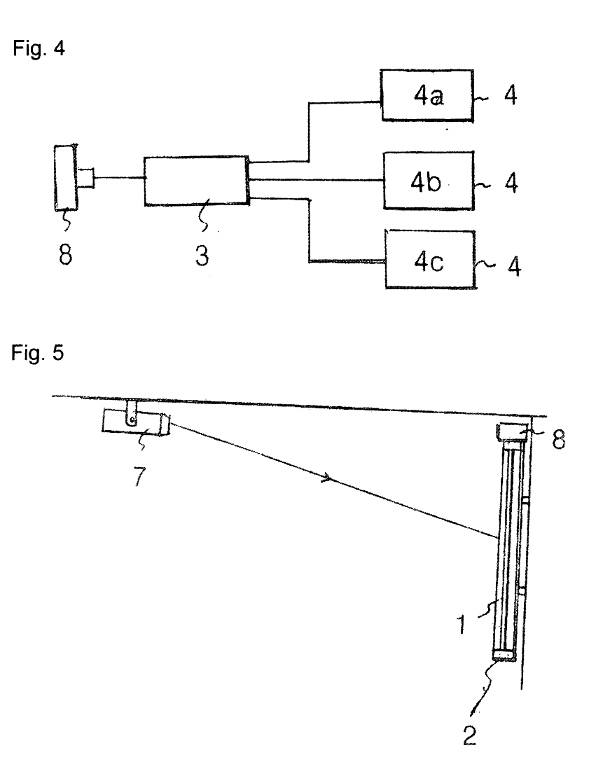

Referring to FIGS. 3 and 4, a sound sensor 3a is positioned at a predetermined location on the frame 2 to detect intensity (dB) of sounds, and is connected to a signal converter 3 which converts the intensity of sounds sent from the sound sensor 3a into electric signals. The signal converter 3 is connected to the lamps 5 which emit different colors according to an output level of the converted signals.

Alternatively, the screen display 2 comprises a lamp controller 3b instead of the sound sensor 3a to light the lamps 5 according to program.

A diffusion plate 6 formed from plastics is attached to a front side of the frame 2 with the lamps 5 disposed therein, and formed thereon with an embossed decoration which can realize various color patterns, thereby improving an appearance of the screen display.

Other features of the embodiment will now be described in detail hereinafter.

The sound sensor 3a of FIG. 3 may have a function of a microphone, and the signal converter 3 may have a function of a sound level meter.

According to the invention, the screen display may further comprise a controller to turn on or off the lamps in various manners.

The sound converter 3 may have a resistor disposed at an output end of the sound converter 3 to output electric signals at different levels corresponding to intensity levels of sound.

One example of variation in illumination or color of the lamps 5 according to the intensity of the sounds will be described hereinafter.

The lamps may be classified according to colors in such a way that a white lamp 4a corresponds to a high level sound, a red lamp 4b corresponds to a medium level sound, and a green lamp 4c corresponds to a low level sound. With this configuration, the high level sound causes the white lamp 4a emitting brightest light to operate, the medium level sound causes the green lamp 4b emitting light of a medium brightness to operate, and the low level sound causes the blue lamp 4c emitting light of a low brightness to operate around the screen display 1.

The colors of the lamps are illustrated as an example in this embodiment, and thus the lamps may emit other various kinds of colors.

Alternatively, the lamps 5 are operated in such a way that the lamp corresponding to the high level sound is repetitiously turned on and off by 1 second, the lamp corresponding to the medium level sound is repetitiously turned on and off by 3 seconds, and the lamp corresponding to the low level sound is repetitiously turned on and off by 6 seconds.

In this way, the sound sensor 3a, signal converter 3 and lamp controller 3b, lamp line 4 and lamps 5 are integrated into the single screen display through the frame 2 surrounding the screen display, such as PDP, LCD, transmissive screen, reflective screen, etc., to which video images are projected from a projector 7, as shown in FIG. 5, so that it is possible to enjoy the variation of the lamps 5 related to the sounds from a speaker as well as the images at the same time.

As apparent from the above description, the screen display 1 of the invention comprises the frame 3 with the lamps 5 and lamp line 4 received therein, and the diffusion plate 6, which has the embossing decoration formed thereon and is positioned on the front side of the frame 3 to cover the lamp line 4, ensuring various patterns of illumination by the lamps to be obtained while providing an attractable appearance to the screen display. In this way, the screen display of the invention improves ornamentation and utility of illuminators such as the lamps by use of the diffusion plate along with the attractable appearance to the screen display.

Furthermore, when applying the screen display of the invention to song rooms, the screen display enables variation of sounds to be expressed as variation of the lamps related to rhythm and intensity of the sound along with images on a single large screen, thereby further increasing the amusement of the singers and audience in the song room.

Furthermore, when applying the screen display of the invention to a video game room, the screen display enables variation of sounds related to contents and illumination of game screens to be expressed as variation of the lamps along with the game screens on the single large screen, thereby further increasing the amusement of gamers.

Furthermore, when applying the screen display of the invention to an advertising display, the screen display enables attraction of customer's eyes towards advertising images on a screen of the display, thereby further increasing an image advertising effect.

It should be understood that the embodiments and the accompanying drawings as described above have been described for illustrative purposes and the present invention is limited by the following claims. Further, those skilled in the art will appreciate that various modifications, additions and substitutions are allowed without departing from the scope and spirit of the invention as set forth in the accompanying claims.

What is claimed is:

1. A screen display, comprising:
a frame surrounding the screen display to couple a plurality of lamps to the screen display;
a lamp line constituted by the plurality of lamps within the frame; and
a sensor connected to the lamp line, wherein variation of the lamps by operation of the sensor is shown on the screen display along with an image.

2. The screen display according to claim 1, further comprising: a signal converter connected to the lamp line.

3. The screen display according to claim 1, further comprising: a diffusion plate having various patterns disposed on a front side of the frame.

4. The screen display according to claim 1, further comprising: an illuminator disposed at one side of the frame to emit laser light in cooperation with the sensor.
